(19) United States
(12) Patent Application Publication
(10) Pub. No.: US 2014/0279462 A1
(43) Pub. Date: Sep. 18, 2014

(54) SYSTEMS AND METHODS FOR INTEGRATED PAYMENT AND ACCOUNTING OF INVOICES

(71) Applicant: INVENTIME USA, INC., San Francisco, CA (US)

(72) Inventor: Francois Nadal, St. Mande (FR)

(73) Assignee: INVENTIME USA, INC., San Francisco, CA (US)

(21) Appl. No.: 14/205,952

(22) Filed: Mar. 12, 2014

Related U.S. Application Data
(60) Provisional application No. 61/777,379, filed on Mar. 12, 2013.

(51) Int. Cl. G06Q 20/10

(52) U.S. Cl. CPC G06Q 20/102
USPC 705/40

(57) ABSTRACT

Systems and methods for integrated payment and accounting server systems in accordance with embodiments of the invention are disclosed. In one embodiment, an accounting and payment server system includes a processor configured to receive invoices including invoice data including third party data identifying the source of the invoice, invoice amount data, invoice date data, and payment period data, generate account payable data using the invoice data, where the account payable data includes at least one payment due date, generate payment request data using the account payable data, transmit the payment request data, receive payment verification data, update the account payable data to include a payment verified date based on the payment verification data, receive account information including payment deduction data, and reconcile the account payable by updating the account payable data to include clearance date data based on the payment deduction data and the payment verified date.

### CROSS REFERENCE TO RELATED APPLICATIONS

The present invention claims priority to U.S. Provisional Patent Application No. 61/777,379, titled “Systems and Methods for Integrated Payment and Accounting of Invoices” and filed Mar. 12, 2013, the entirety of which is hereby incorporated by reference.

### FIELD OF THE INVENTION

The present invention relates to accounting systems and more specifically to the integration of accounting and payment systems.

### BACKGROUND

Businesses of all sizes rely upon a variety of enterprise software applications as part of their day-to-day operations and one or more financial institutions to process their payments. In many instances, a business will utilize a first software package for accounting, a second software package for customer relationship management, another software package for document management, and a fourth software package for payment processing.

In accounting, accounts payable is money owed by a business to a third party for services rendered and/or goods provided by the third party. An account payable indicates that the business has an outstanding debt to a third party that needs to be repaid according to the terms of the agreement with the third party. This outstanding debt appears on an accounting ledger as an open liability until it is paid, when the ledger is updated to reflect that the debt has been repaid.

### SUMMARY OF THE INVENTION

Systems and methods for integrated payment and accounting server systems in accordance with embodiments of the invention are disclosed. In one embodiment, an accounting and payment server system includes a processor, a network interface connected to the processor, and memory connected to the processor and configured to store an accounting and payment application, wherein the accounting and payment application configures the processor to receive invoices including invoice data, where the invoice data includes third party data identifying the source of the invoice, invoice amount data, invoice date data, and payment period data, generate account payable data using the invoice data, where the account payable data includes at least one payment due date, generate payment request data using the account payable data, transmit the payment request data using the network interface, receive payment verification data using the network interface, update the account payable data to include a payment verified date based on the payment verification data, receive account information using the network interface, where the account information includes payment deduction data, and reconcile the account payable by updating the account payable data to include clearance date data based on the payment deduction data and the payment verified date.

In an additional embodiment of the invention, the invoice data includes payment discount data, the payment request data includes payment amount data, and the accounting and payment application configures the processor to determine the payment amount data using the invoice amount data and the payment discount data.

In another embodiment of the invention, the account payable data includes prioritization data and the accounting and payment application further configures the processor to determine the prioritization data for the account payable data using the payment due date data and the payment amount data.

In yet another additional embodiment of the invention, the accounting and payment application further configures the processor to determine prior payment data using the third party data and determine the prioritization data using the prior payment data.

In still another additional embodiment of the invention, the accounting and payment application further configures the processor to retrieve financial institution balance data using the network interface.

In yet still another additional embodiment of the invention, the accounting and payment application further configures the processor to determine cash position data using the financial institution balance data and the generated payment request data and schedule the payment request data using the cash position data and the prioritization data.

In yet another embodiment of the invention, the accounting and payment application further configures the processor to schedule the payment request data using the financial institution balance data and the prioritization data.

In still another embodiment of the invention, the accounting and payment application further configures the processor to transmit payment authorization data using the network interface, the payment authorization includes a token corresponding to the payment authorization data, and the token can be utilized to track the payment authorization data.

In yet still another embodiment of the invention, the system includes a microphone connected to the processor and the accounting and payment application further configures the processor to receive the payment authorization data using the microphone.

In yet another additional embodiment of the invention, the accounting and payment application further configures the processor to direct a user to a payment processor user interface hosted by a payment processor server system separate from the accounting and payment server system and the payment processor user interface is configured to allow the user to authorize payment requests based on at least one token corresponding to the authorize payment requests transmitted to the payment processor server system.

Still another embodiment of the invention includes a method for accounting and payment of invoices including receiving invoices including invoice data using an accounting and payment server system, where the invoice data includes third party data identifying the source of the invoice, invoice amount data, invoice date data, and payment period data, generating account payable data using the invoice data and the accounting and payment server system, where the account payable data includes at least one payment due date, generating payment request data using the account payable data and the accounting and payment server system, transmitting the payment request data using the accounting and payment server system, receiving payment verification data using the accounting and payment server system, updating the account payable data to include payment verified date using the payment verification data and the accounting and payment server system, receiving account information using the accounting and payment server system, where the account information includes payment deduction data, and reconciling the account payable by associating clearance date data using the payment deduction data, the payment verified date, and the accounting and payment server system.

In yet another additional embodiment of the invention, the method further includes determining payment amount data included in the payment request data using the invoice amount data, payment discount data included in the invoice data, and the accounting and payment server system.

In still another additional embodiment of the invention, the method further includes determining prioritization data included in the account payable data using the payment due date data, the payment amount data, and the accounting and payment server system.

In yet still another additional embodiment of the invention, the method further includes determining prior payment data using the third party data and the accounting and payment server system and determining the prioritization data using the prior payment data and the accounting and payment server system.

In yet another embodiment of the invention, the method further includes retrieving financial institution balance data using the accounting and payment server system.

In still another embodiment of the invention, the method further includes determining cash position data using the financial institution balance data, the generated payment request data, and the accounting and payment server system and scheduling the payment request data using the cash position data, the prioritization data, and the accounting and payment server system.

In yet still another embodiment of the invention, the method further includes scheduling the payment request data using the financial institution balance data, the prioritization data, and the accounting and payment server system.

In yet another additional embodiment of the invention, the method further includes transmitting payment authorization data using the accounting and payment server system, where the payment authorization data is transmitted using a token associated with the payment authorization data and the token can be utilized to track the payment authorization data using the accounting and payment server system.

In still another additional embodiment of the invention, the method further includes receiving the payment authorization data using the accounting and payment server system.

In yet still another additional embodiment of the invention, the method further includes directing a user to a payment processor user interface hosted by a payment processor server system separate from the accounting and payment server system using the accounting and payment server system, where the payment processor user interface is configured to allow the user to authorize payment requests based on at least one token corresponding to the payment requests transmitted to the payment processor server system.

### BRIEF DESCRIPTION OF THE DRAWINGS

FIG. 1 is a conceptual illustration of an accounting system including an accounting and payment server system in accordance with an embodiment of the invention.

FIG. 2 is a conceptual illustration of an accounting and payment server system in accordance with an embodiment of the invention.

FIG. 3 is a flow chart conceptually illustrating a process for accounting and paying a received invoice in accordance with an embodiment of the invention.

FIG. 4 is a flow chart conceptually illustrating a process for accounting for and payment of a received invoice with a remote payment system in accordance with an embodiment of the invention.

FIG. 5 is a flow chart conceptually illustrating a process for scheduling accounts payable in accordance with an embodiment of the invention.

### DETAILED DESCRIPTION

Turning now to the drawings, systems and methods for integrated payment and accounting server systems in accordance with embodiments of the invention are disclosed. During the operation of a business, businesses procure goods and services from a variety of third party vendors. As most vendors do not work for free, the vendors invoice the business for the services and/or goods provided. Invoices include a variety of invoice terms such as, but not limited to, the amount of the payment, the time period for payment, the method of payment, and other payment terms including agreements for discounting and/or penalties for the invoice. A business needs to track and pay received invoices as part of the operation of the business. In order to track received invoices, businesses generate accounts payable as part of the accounting practices of the business; an account payable is generated using a received invoice so that the business can properly account for and track the receipt and payment of the invoice.

Businesses maintain bank and/or other credit accounts to manage the cash necessary for the business to conduct its operations, including paying its bills. Businesses can maintain these accounts with a variety of financial institutions such as banks and credit providers in accordance with embodiments of the invention. Once an account payable becomes due, the business writes a check or contacts the financial institution to provide payment for the account payable. At the end of the month, the financial institution provides a statement of all the payments the business made via the financial institution during that month; the business then reconciles the payments processed by the financial institution with the accounts payable that the business has recorded in its accounting system. This disconnect between the generation of the account payable, the payment of the account payable, and the reconciliation of the payment with the account can lead to uncertainties in the cash position of the business and the status of one or more of the accounts payable. In addition, the process of reconciling bank accounts with accounts payable is prone to errors due in part to lost or misplaced information. These delays and uncertainties can lead to a variety of situations that are less than ideal for a business, such as spending cash that is not available, failing to pay invoices, and paying invoices more than once.

Accounting and payment server systems in accordance with embodiments of the invention are configured to receive invoices, generate accounts payable, pay the accounts payable, and automatically reconcile the payments made with the accounts payable. In a variety of embodiments, the accounting and payment server system is configured to analyze the cash position of the business and schedule the payment of accounts payable based on the cash available to the business. In several embodiments, the accounting and payment server system identifies the payment terms associated with the invoice, such as, but not limited to, discounts and payable dates, and schedules payment of the accounts payable associated with the invoices using the payment terms of the invoice. To pay accounts payable, accounting and payment server systems communicate with payment processor server systems to schedule payments and/or retrieve payment data. In a number of embodiments, accounting and payment server systems communicate with financial institution server systems in order to track the cash position of the business to aid in the scheduling and payment of accounts payable. In many embodiments, accounting and payment server systems automatically reconcile the cash position of the business according to the financial institution server system with the payments made via the payment processor server systems. Accounting and payment server systems also provide a variety of interfaces to allow users to enter, review, and modify invoices, accounts payable, cash positions, and allow users to authorize the payment of accounts payable.

Accounting and payment server systems and methods for accounting, scheduling, and payment of invoices in accordance with embodiments of the invention are discussed further below.

### System Architecture

Accounting systems in accordance with embodiments of the invention are configured to facilitate the receipt and processing of invoices. The processing of an invoice includes accounting for the receipt of an invoice, paying the invoice, and automatically accounting for the payment of the invoice. An accounting system in accordance with an embodiment of the invention is conceptually illustrated in FIG. 1. The accounting system 100 includes an accounting and payment server system 110 in communication with a financial server system 120, a payment processor server system 122, and a variety of client devices, such as, but not limited to, mobile devices 130 and personal computers 132 via a network 140. In a number of embodiments, the network 140 is the Internet. In several embodiments, the financial server system 120 and the payment processor 122 are the same entity; in other embodiments, the financial server system 120 and the payment processor server system 122 are separate entities.

The accounting and payment server system 110 is configured to receive invoices via the network 140 and/or load processed invoices. Accounting and payment server system 110 is configured to process invoices via a variety of techniques, such as by manual entry, via a character recognition process, or other techniques in accordance with the requirements of embodiments of the invention. The accounting and payment server system 110 is further configured to generate an account payable using the processed invoice, where the account payable includes a variety of data taken from the invoice, such as the amount of payment, the time period for payment, the method of payment, and terms or other agreements for discounting and/or penalties for the invoice. Other invoice data can be included in an account payable in accordance with the specific requirements of embodiments of the invention. Once an account payable has been generated, the accounting and payment server system 110 is configured to provide the payment of the account payable by generating payment request data to be transmitted to the payment processor server system 122 and/or the financial server system 120. The accounting and payment server system 110 is further configured to retrieve a payment confirmation from the payment processor server system 122 and/or the financial institution server system 120. Once the payment has been made, the accounting and payment server system 110 is configured to update the account payable to indicate the amount of the payment and the date of the payment. Other data can be included in the account payable, including the method of payment and the payment processor server system 122 utilized to make the payment, in accordance with a variety of embodiments of the invention. In many embodiments, the accounting and payment server system 110 is configured to receive a statement from the financial institution server system 120 and/or the payment processor server system 122 including transaction data related to the payments deducted from the accounts associated with the business; the transaction and payment server system 110 is configured to reconcile the received transaction data with the accounts payable. In a variety of embodiments, reconciling the received transaction data includes updating the account payable data to reflect the fact that the payments have cleared the financial institution server system 120 and/or the payment processor server system 122; other reconciliation techniques can be utilized in accordance with embodiments of the invention.

The accounting and payment server system 110 is configured to transmit payment request data and request payment confirmation data from the payment processor server system 122 via an application programming interface (API). Likewise, the accounting and payment server system 110 is configured to request financial institution account information, such as, but not limited to, the cash available in accounts for the business and any transactions related to the accounts, from the financial institution server system 120 via an API. A variety of APIs can be utilized in accordance with embodiments of the invention, including web services and vendor-specific APIs. Data can be transmitted and received via the API using one or more of a variety of standard formats, including the eXtensible Business Reporting Language (XBRL), the Portable Document Format (PDF), a comma delimited format, a semicolon delimited format, a tab delimited format, the Uniform Bank Performance Report (UBPR), the Home Banking Computer Interface (NBCI), the Financial Transaction Service (FinTS), Secure Electronic Transaction (SET), 3-D Secure, Open Financial Exchange (OFX), Open Financial Connectivity (OFC), Open Exchange, Interactive Financial Exchange (IFX), and the eXtensible Markup Language (XML). APIs and data formats not specifically listed above can be utilized in accordance with the requirements of a specific applications in accordance with embodiment of the invention.

In several embodiments, the accounting and payment server system 110 is configured to schedule the payment of the accounts payable. In a variety of embodiments, the accounting and payment server system 110 is configured to determine the cash position of the business using account information received from the financial institution server system 120, payment information received from the payment processor server system 122, and/or the generated accounts payable. In a number of embodiments, the accounting and payment server system 110 uses the cash position of the business to improve the scheduling of payments of accounts payable. In many embodiments, the accounting and payment server system 110 is configured to use payment term data associated with one or more accounts payable to improve the scheduling of the accounts payable.

In many embodiments, accounting and payment server systems provide a user interface, such as a web interface or a software application, to allow users to view and authorize payments, such as via personal computer 132 or a mobile device 130. In several embodiments, the user interface displays a list of accounts payable sorted by due date; the user is able to pay accounts payable individually and/or via a bulk payment option. In a variety of embodiments, the user interface utilizes voice recognition techniques and employs text-to-speech capabilities to allow a user to speak commands to the accounting and payment server system and receive audible feedback from the accounting and payment server system via a mobile device 130 and/or personal computer 132. In many embodiments, the user interface allows the user to view the cash position of the business and/or view the transactions received from the financial institution server system 120 and/or the payment processor server system 122.

Although specific accounting systems in accordance with embodiments of the invention are discussed above, any of a variety of system architectures that provide the accounting and payment of invoices can be utilized in accordance with embodiments of the invention including architectures not specifically described above. Additionally, any of the various systems and processes described herein can be performed in sequence, in alternative sequences, and/or in parallel (e.g. on different computing devices) in order to achieve similar results in a manner that is more appropriate to the requirements of a specific application of the invention. Accounting and payment server systems and methods for accounting and payment of invoices in accordance with embodiments of the invention are discussed further below.

### Accounting and Payment Server Systems

Accurate accounting practices facilitate the ability of a business to keep up with the payments demanded of the business and understand the current financial position of the business. Accounting and payment server systems allow businesses to integrate accounting of invoices received with payment of those invoices to streamline the accounting related to the invoices, thereby enabling a business to accurately track the financial position of the business. An accounting and payment server system in accordance with an embodiment of the invention is conceptually illustrated in FIG. 2. The accounting and payment server system 200 includes a processor 210 in communication with volatile memory 220 and non-volatile memory 230. The accounting and payment server system 200 also includes a network interface 240 configured to send and receive data over a network connection. In a number of embodiments, the network interface 240 is in communication with the processor 210, the non-volatile memory 230, and the volatile memory 220.

In several embodiments, non-volatile memory is any form of non-volatile storage configured to store a variety of data, including, but not limited to, accounting data 234 and payment data 236. Accounting data 234 includes data utilized in the accounting of a business's books (e.g. accounting records), including the financial institution accounts maintained by the business, the cash balance for those financial institution accounts, outstanding accounts payable, outstanding payments made, and outstanding accounts receivable. Payment data 236 includes data utilized in the payment of an account payable, such as the account payable, the amount to be paid, the payment processor utilized to pay the account payable, and the date to make the payment. Other accounting data 234 and/or payment data 236 can be utilized in accordance with the requirements of specific embodiments of the invention.

In the illustrated embodiment, the non-volatile memory 230 is also configured to store an accounting and payment application 232 that configures the processor 210 to perform accounting and payment processes. Accounting and payment processes include generating accounts payable, requesting payment of the accounts payable, and reconciling the payments with the accounts payable. In several embodiments, requesting payment of an account payable includes transmitting payment request data to a payment processor server system using the network interface 240 that instructs the payment processor server system to process a payment for a particular amount to the third party associated with (or the third party's financial institution) the account payable. In a number of embodiments, reconciling the payments with accounts payable includes receiving account information from a financial institution server system via the network interface 240 and matching the received account information to the accounts payable and/or payment request data. In several embodiments, the accounting and payment application 232 configures the processor 210 to generate a schedule for payment of the accounts payable using the received account information and/or the account payable data associated with one or more accounts payable. The accounting and payment application 232 can configure the processor 210 to perform other accounting and/or payment processes in accordance with the requirements of a variety of embodiments of the invention.

In many embodiments, the accounting data 234 and/or the payment data 236 are stored using an external server system and received by the accounting and payment server system 200 using the network interface 240. External server systems in accordance with a variety of embodiments include, but are not limited to, financial institution server systems and payment processor server systems. In several embodiments, the processor 210 is configured to transmit accounting data 234 and/or payment data 236 using the network interface 240. In a number of embodiments, the processor 210 is configured to transmit and/or receive accounting data 234 and/or payment data 236 via an API call to a financial institution server system and/or a payment processor server system.

Although a specific architecture for an accounting and payment server system in accordance with an embodiment of the invention is conceptually illustrated in FIG. 2, any of a variety of architectures, including those which store data or applications on disk or some other form of storage and are loaded into volatile memory 220 at runtime, and or systems that are distributed across multiple physical servers, can also be utilized. Methods for accounting for and payment of received invoices in accordance with embodiments of the invention are discussed further below.

### Accounting for and Paying Received Invoices

As a business receives invoices from third parties, the business creates accounts payable from the invoices in their accounting system. Once the invoice is paid, the business then reconciles the payment with the appropriate account payable in the accounting system. Accounting and payment server systems in accordance with embodiments of the invention are configured to integrate the accounting and payment of invoices to provide accurate accounting of payments. A process for generating accounting data for a received invoice, paying the invoice, and reconciling the payment with the accounting data is conceptually illustrated in FIG. 3. The process 300 includes receiving (310) an invoice and an account payable is created (312). A payment is generated (314). In a variety of embodiments, the payment is verified (316). The account payable and payment are reconciled (318).

In a variety of embodiments, receiving (310) an invoice is performed by manually creating invoice data using the received (310) invoice information. In several embodiments, receiving (310) an invoice is performed by performing character recognition on a paper invoice. In many embodiments, receiving (310) an invoice includes processing a digitally received invoice, such as by parsing invoice data from the digitally received invoice. In a number of embodiments, an accounting and payment server system is configured to receive (310) invoices and/or retrieve invoices from a third party server via an API and process the received (310) invoice. Processing of invoices includes identifying relevant invoice information in the invoice and creating invoice data using the relevant invoice information. A variety of invoice data can be processed from the received (310) invoice, such as the third party issuing the invoice, the amount of the invoice, the date the invoice was issued, the number of days to pay the invoice, the payment date of the invoice, and any additional payment terms for the invoice. In a variety of embodiments, creating (312) an account payable includes generating account payable data containing the invoice data within the received (310) invoice. Account payable data also includes other accounting details, such as the payment processor used to make the payment, the date payment was requested, the date payment was verified, and the date payment was cleared. Other data can be included in an account payable in accordance with a variety of embodiments of the invention.

In several embodiments, generating (314) a payment includes creating a payment request for a payment processor server system. Payment requests include a variety of payment request data, including, but not limited to, the third party to which the payment should be made, the amount of payment to be made, any deductions or penalties applied to the payment amount, the account from which the payment should be taken, the date on which to transmit the payment, the form of payment (e.g. cash, check, wire transfer), and the invoice to which the payment should be applied. Other information can be included in a payment request depending on the requirements of specific applications in accordance with embodiments of the invention. Payment processor server systems receive payment requests, send payments to the indicated parties, and withdraw the amount of the payment from the account indicated in the payment request. In a number of embodiments, an accounting and payment server system is configured as a payment processor server system. In many embodiments, verifying (316) a payment includes receiving payment confirmation data from the payment processor server system. In a number of embodiments, verifying (316) a payment includes requesting payment confirmation data from a payment processor server system and/or determining if a payment has been processed by examining an account history in account information received from the payment processor server system. In several embodiments, reconciling (318) the account payable with the payment includes updating the created (312) account payable with the generated (314) payment request data and/or the verified (316) payment confirmation data. In many embodiments, reconciling (318) the account payable with the payment includes receiving an account statement including cleared payment data from a financial institution server system, locating the generated (314) payment request data in the cleared payment data, and updating the created (312) account payable to reflect the appearance of the payment request data in the account statement. In several embodiments, the accounting and payment server system provides tokens to the payment processor server system and account information received from the payment processor server system includes the tokens corresponding to each processed payment. In this way, the accounting and payment server system can reconcile payments against outstanding payment requests by matching tokens.

Although a specific process for generating accounting data for a received invoice, paying the invoice, and reconciling the payment with the accounting data is described above with respect to FIG. 3, a variety of processes can be utilized in accordance with the requirements of embodiments of the invention. Methods for accounting for and paying received invoices with remote payment authorization are discussed further below.

Accounting of and Paying Received Invoices with Remote Payment Authorization

A number of payment processors and financial institutions do not allow payment requests to be made automatically. These processors and institutions utilize payment authorizations before a payment request will be processed. Accounting and payment server systems are configured to generate payment requests and direct users to the corresponding institution to provide payment authorizations. A process for generating accounting data for a received invoice, paying the invoice, and reconciling the payment with accounting data associated with remote payment authorizations is conceptually illustrated in FIG. 4. The process 400 includes receiving (410) an invoice. An account payable is created (412). A payment request is generated (414). Payment requests are transmitted (416). Payment requests are authorized (418). In several embodiments, payments are verified (420). The account payable and payment are reconciled (420).

In several embodiments, processes similar to those described above can be utilized to receive (410) invoices. Processes similar to those described above are utilized to create (412) accounts payable in a number of embodiments of the invention. In a variety of embodiments, payment requests are generated (414) utilizing processes similar to those described above. One or more payment requests can be transmitted (416) to a payment processor server system in accordance with many embodiments of the invention. In a number of embodiments, transmitting (416) payment requests to a payment processor includes redirecting a user to a website and/or service provided by the payment processor server system to view the transmitted (416) payment requests. In several embodiments, users can manually visit the payment processor server system to view the transmitted (416) payment requests. In many embodiments, payment requests are authorized (418) via the website and/or services provided by the payment processor server system. In a variety of embodiments, payment requests can be authorized (418) via the accounting and payment server system via an API call to the payment processor server system. In a number of embodiments, verifying (420) a payment or payments utilizes processes similar to those described above. In several embodiments, reconciling (422) accounts payable and payments is performed utilizing processes similar to those described above.

Although a specific process for generating accounting data for a received invoice, paying the invoice, and reconciling the payment with the accounting data with remote payment authorization is described above with respect to FIG. 4, a variety of processes can be utilized in accordance with the requirements of embodiments of the invention. Techniques for reconciling and generating accounts payable are discussed further below.

### Scheduling Accounts Payable Payments

To pay an invoice, a business usually must have sufficient cash on hand or credit available. Invoices can include discounts for payment by a certain date and/or penalties for failure to pay by a certain date. Accounting and payment server systems in accordance with embodiments of the invention are configured to determine to schedule the payment of accounts payable based upon the cash a business has available and/or the terms of the invoice to be paid. A process for reconciling and generating accounts payable in accordance with an embodiment of the invention is conceptually illustrated in FIG. 5. The process 500 includes generating (510) open accounts payable. A cash position is determined (512). Available cash is determined (514). Payment dates are calculated (516). In several embodiments, payments are prioritized (518). Accounts payable are scheduled (520) for payment.

In a variety of embodiments, generating (510) open accounts payable is performed using processes similar to those described above. In several embodiments, determining (512) the cash position for a business includes receiving account information from one or more financial institution server systems. In many embodiments, the cash position for the business is the sum of the values of at least one account in the received account information; other methods for determining the cash position of a business can be utilized in accordance with the requirements of a specific applications in accordance with embodiments of the invention. In a number of embodiments, determining (514) available cash includes deducting the value of any outstanding payment requests received from one or more payment processor server systems from the determined (512) cash position for the business. In a variety of embodiments, a payment date is calculated (516) using the invoice data associated with an open account payable. In several embodiments, the invoice data includes the date the invoice associated with the account payable was received and the payment period for the invoice. Multiple payment dates can be calculated (516) for an account payable when multiple payment periods are associated with the account payable. In this way, partial payments can be provided for one or more invoices. In many embodiments, payments are prioritized (518) using the date the payment is due. In several embodiments, payments are prioritized (518) using discounts and/or penalties for paying the account payable before and/or after the calculated (516) payment date. In a number of embodiments, payments are prioritized (518) based upon previous payments made to the same third party and/or other third parties. In a variety of embodiments, payments are prioritized based upon the determined (514) cash available. In many embodiments, accounts payable are scheduled (520) for payment based on the order they are received. In a number of embodiments, accounts payable are scheduled (520) for payment based on the priority of the payment for the accounts payable. In several embodiments, the schedule (520) for paying accounts payable is manually modified.

A specific process for scheduling accounts payable is described above with respect to FIG. 5; however, a variety of processes, including those utilizing prioritization techniques not discussed above, can be utilized in accordance with the requirements of embodiments of the invention.

Although the present invention has been described in certain specific aspects, many additional modifications and variations would be apparent to those skilled in the art. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. An accounting and payment server system, comprising:
a processor;
a network interface connected to the processor; and
memory connected to the processor and configured to store an accounting and payment application;
wherein the accounting and payment application configures the processor to:
receive invoices comprising invoice data, where the invoice data comprises third party data identifying the source of the invoice, invoice amount data, invoice date data, and payment period data;
generate account payable data using the invoice data, where the account payable data comprises at least one payment due date;
generate payment request data using the account payable data;
transmit the payment request data using the network interface;
receive payment verification data using the network interface;
update the account payable data to comprise a payment verified date based on the payment verification data;
receive account information using the network interface, where the account information comprises payment deduction data; and
reconcile the account payable by updating the account payable data to comprise clearance date data based on the payment deduction data and the payment verified date.

2. The accounting and payment server system of claim 1, wherein:
the invoice data comprises payment discount data;
the payment request data comprises payment amount data; and
the accounting and payment application configures the processor to determine the payment amount data using the invoice amount data and the payment discount data.

3. The accounting and payment server system of claim 1, wherein:
the account payable data comprises prioritization data; and
the accounting and payment application further configures the processor to determine the prioritization data for the account payable data using the payment due date data and the payment amount data.

4. The accounting and payment server system of claim 3, wherein the accounting and payment application further configures the processor to:
determine prior payment data using the third party data; and
determine the prioritization data using the prior payment data.

5. The accounting and payment server system of claim 3, wherein the accounting and payment application further configures the processor to retrieve financial institution balance data using the network interface.

6. The accounting and payment server system of claim 5, wherein the accounting and payment application further configures the processor to:
determine cash position data using the financial institution balance data and the generated payment request data; and
schedule the payment request data using the cash position data and the prioritization data.

7. The accounting and payment server system of claim 5, wherein the accounting and payment application further configures the processor to schedule the payment request data using the financial institution balance data and the prioritization data.

8. The accounting and payment server system of claim 1, wherein:
the accounting and payment application further configures the processor to transmit payment authorization data using the network interface;
the payment authorization comprises a token corresponding to the payment authorization data; and
the token can be utilized to track the payment authorization data.

9. The accounting and payment server system of claim 8, further comprising a microphone connected to the processor;
wherein the accounting and payment application further configures the processor to receive the payment authorization data using the microphone.

10. The accounting and payment server system of claim 1, wherein:
the accounting and payment application further configures the processor to direct a user to a payment processor user interface hosted by a payment processor server system separate from the accounting and payment server system; and
the payment processor user interface is configured to allow the user to authorize payment requests based on at least one token corresponding to the authorize payment requests transmitted to the payment processor server system.

11. A method for accounting and payment of invoices, comprising:
receiving invoices comprising invoice data using an accounting and payment server system, where the invoice data comprises third party data identifying the source of the invoice, invoice amount data, invoice date data, and payment period data;
generating account payable data using the invoice data and the accounting and payment server system, where the account payable data comprises at least one payment due date;
generating payment request data using the account payable data and the accounting and payment server system;
transmitting the payment request data using the accounting and payment server system;
receiving payment verification data using the accounting and payment server system;
updating the account payable data to comprise payment verified date using the payment verification data and the accounting and payment server system;
receiving account information using the accounting and payment server system, where the account information comprises payment deduction data; and
reconciling the account payable by associating clearance date data using the payment deduction data, the payment verified date, and the accounting and payment server system.

12. The method of claim 11, further comprising determining payment amount data included in the payment request data using the invoice amount data, payment discount data included in the invoice data, and the accounting and payment server system.

13. The method of claim 11, further comprising determining prioritization data included in the account payable data using the payment due date data, the payment amount data, and the accounting and payment server system.

14. The method of claim 13, further comprising:
determining prior payment data using the third party data and the accounting and payment server system; and
determining the prioritization data using the prior payment data and the accounting and payment server system.

15. The method of claim 13, further comprising retrieving financial institution balance data using the accounting and payment server system.

16. The method of claim 15, further comprising:
determining cash position data using the financial institution balance data, the generated payment request data, and the accounting and payment server system; and
scheduling the payment request data using the cash position data, the prioritization data, and the accounting and payment server system.

17. The method of claim 15, further comprising scheduling the payment request data using the financial institution balance data, the prioritization data, and the accounting and payment server system.

18. The method of claim 11, further comprising transmitting payment authorization data using the accounting and payment server system, where the payment authorization data is transmitted using a token associated with the payment authorization data and the token can be utilized to track the payment authorization data using the accounting and payment server system.

19. The method of claim 18, further comprising receiving the payment authorization data using the accounting and payment server system.

20. The method of claim 11, further comprising directing a user to a payment processor user interface hosted by a payment processor server system separate from the accounting and payment server system using the accounting and payment server system, where the payment processor user interface is configured to allow the user to authorize payment requests based on at least one token corresponding to the payment requests transmitted to the payment processor server system.
